(19) United States
(12) Patent Application Publication
(10) Pub. No.: US 2015/0247815 A1
(43) Pub. Date: Sep. 3, 2015

(54) CORROSION SENSOR AND METHOD OF USING SAME

(71) Applicant: Purdue Research Foundation, West Lafayette, IN (US)

(72) Inventors: Dong Chen, Fort Wayne, IN (US); S.C. Max Yen, Fort Wayne, IN (US); Paul I-Hai Lin, Fort Wayne, IN (US)

(73) Assignee: PURDUE RESEARCH FOUNDATION, West Lafayette, IN (US)

(21) Appl. No.: 14/179,501

(22) Filed: Feb. 12, 2014

Related U.S. Application Data
(60) Provisional application No. 61/763,523, filed on Feb. 12, 2013.

(51) Int. Cl. G01N 27/22; G01N 27/04; G01N 17/02

(52) U.S. Cl. CPC G01N 27/22; G01N 17/02; G01N 27/041

(57) ABSTRACT

A corrosion sensor to automatically monitor the extent of corrosion in various structures is disclosed. The corrosion sensor includes a first part made substantially similar in material construction to a structure, corrosion on which is to be sensed by the corrosion sensor, and a second part made of a corrosion-resistant material, the first and second parts being separated by a medium, thereby forming a capacitor. The capacitor configured such that change in the capacitance provides a measure of corrosion occurring in the structure.

### CROSS-REFERENCE TO RELATED APPLICATIONS

The present U.S. patent application is related to and claims the priority benefit of U.S. Provisional Patent Application Ser. No. 61/763,523, filed Feb. 12, 2013, the contents of which are hereby incorporated by reference in its entirety into the present disclosure.

### STATEMENT REGARDING GOVERNMENT FUNDING

This invention was made with government support under W9132T-10-2-0056 awarded by the U.S. Army Construction Engineering Research Lab. The government has certain rights in the invention.

### TECHNICAL FIELD

This disclosure relates to sensors capable of sensing corrosion occurring in structures and methods of using such sensors.

### BACKGROUND

Corrosion is the destructive attack on a metal such as carbon steel, aluminum, zinc and copper by chemical or electrochemical reactions with its environment. It is a spontaneous process. When these metals are used in structures (including infrastructures) and systems, corrosion is detrimental to the function, the stability, and the safety of the whole system. Corrosion is an inherent problem which affects the construction, transportation, energy and many other industries. If corrosion is not monitored and addressed, it could result in undesirable consequences.

Among various causes of corrosion, environmental factors are the most common. Practically all environments are corrosive to some degree. Some examples are air and moisture; fresh, distilled, salt, and mine waters; steam and other gases such as chlorine, ammonia, hydrogen sulfide, and fuel gases; mineral and organic acids. Among these environmental factors, chloride is an important one. It is well known that chloride ions can cause passive layer breakdown and corrosion of metals. Structures can be exposed to chloride ions through various means including deicing salts, fresh water, and a marine environment. Detection of the early-stage environmental corrosion is very important to maintain the integrity and the safety of the structures and the systems, because the corrosion can be a self-accelerating process when no corrosion inhibitors are present.

Manual inspection of corrosion is costly, inefficient, subjective and sometimes dangerous. It typically requires a large amount of time for professionals to travel and inspect each site. When there are difficult-to-access or completely inaccessible areas, frequent manual inspections are almost impossible.

Thus, it is highly desirable to use corrosion sensors for automatic data collection, processing, and evaluation. Thus a need exists for new corrosion sensors that enable automatic and frequent monitoring of corrosion without the need for site visitation.

### SUMMARY

A corrosion sensor to automatically monitor the extent of corrosion in various structures is disclosed. The corrosion sensor includes a first part made substantially similar in material construction to a structure, corrosion on which is to be sensed by the corrosion sensor, and a second part made of a corrosion-resistant material, the first and second parts being separated by a medium, thereby forming a capacitor. The capacitor configured such that change in the capacitance provides a measure of corrosion occurring in the structure.

Also disclosed is a corrosion sensing system for measuring the corrosion of a structure. The corrosion sensing system includes at least one corrosion sensor, including a first part made substantially similar in material construction to a structure, corrosion on which is to be sensed by the corrosion sensor, and a second part made of a corrosion-resistant material, the first and second parts being separated by a medium, thereby forming a capacitor, the capacitor configured such that change in the capacitance provides a measure of corrosion occurring in the structure. The corrosion sensing system further includes at least one reference sensor, including a first and second corrosion resistant parts made of a corrosion-resistant material, the first and second corrosion resistant parts being separated by a reference medium, thereby forming a reference capacitor, substantially unaffected by corrosion occurring to the at least one corrosion sensor. The corrosion sensing system further includes an energization and interrogation circuit configured to energize and measure resistance and capacitance of the at least one corrosion sensor and the at least one reference and communicate the measured values to a base station.

Also described herein is a method of estimating extent of corrosion of a structure. The method includes installing at least one corrosion sensor in close proximity to the structure. The corrosion sensor includes a first part made substantially similar in material construction to the structure, and a second part made of a corrosion-resistant material, the first and second parts being separated by a medium, thereby forming a capacitor. The capacitor configured such that a change in the capacitance provides a measure of corrosion occurring in the structure. The method further includes establishing a set of baseline of values for resistance and capacitance values for the at least one corrosion sensor. The method also includes measuring instantaneous resistance and capacitance values of the at least one corrosion sensor. The method further includes communicating the instantaneous resistance and capacitance values to a data analysis station. The method includes estimating the instantaneous extent of corrosion of the structure based on the communicated instantaneous resistance and capacitance values.

### BRIEF DESCRIPTION OF DRAWINGS

FIG. 1 is a block diagram of an exemplary system for energization and interrogation of a corrosion sensor arrangement, according to the present disclosure.

FIG. 2 is a schematic representation of an electrical circuit showing the resistance and capacitance of a corrosion sensor of the present disclosure.

FIG. 3 is a perspective view of an embodiment of the corrosion sensor according to the present disclosure in form of a cylindrical capacitor.

FIG. 4 is a graph of iron loss rate and accumulated iron loss vs. time in 0.2M NaCl solution during a test of corrosion sensor containing A36 steel.

FIGS. 5(a) and 5(b) are X-ray Diffraction patterns of uncorroded and corroded A36 samples respectively.

FIG. 6(a) is a graph of parallel resistance of a corrosion sensor vs. time in 0.2 M NaCl solution.

FIG. 6(b) is a graph of series resistance of a corrosion sensor vs. time in 0.2 M NaCl solution.

FIG. 7(a) is a graph of parallel capacitance of a corrosion sensor vs. time in 0.2 M NaCl solution.

FIG. 7(b) is a graph series capacitance of a corrosion sensor vs. time in 0.2 M NaCl solution.

FIG. 8 is a schematic representation of a method employed for estimating corrosion, according to the present disclosure.

FIG. 9(a) is a graph of parallel normalized resistance (R/R₀) of a corrosion sensor vs. time in 0.2 M NaCl solution, normalized based on a corrosion-resistant sensor, according to the present disclosure.

FIG. 9(b) is a graph of series normalized resistance (R/R₀) of a corrosion sensor vs. time in 0.2 M Nacl solution, normalized based on a corrosion-resistant sensor, according to the present disclosure.

FIG. 10(a) is a graph of parallel normalized capacitance (C/C₀) of a corrosion sensor vs. time in 0.2 M NaCl solution, normalized based on a corrosion-resistant sensor, according to the present disclosure.

FIG. 10(b) is a graph of series normalized capacitance (C/C₀) of a corrosion sensor vs. time in 0.2 M NaCl solution, normalized based on a corrosion-resistant sensor, according to the present disclosure.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

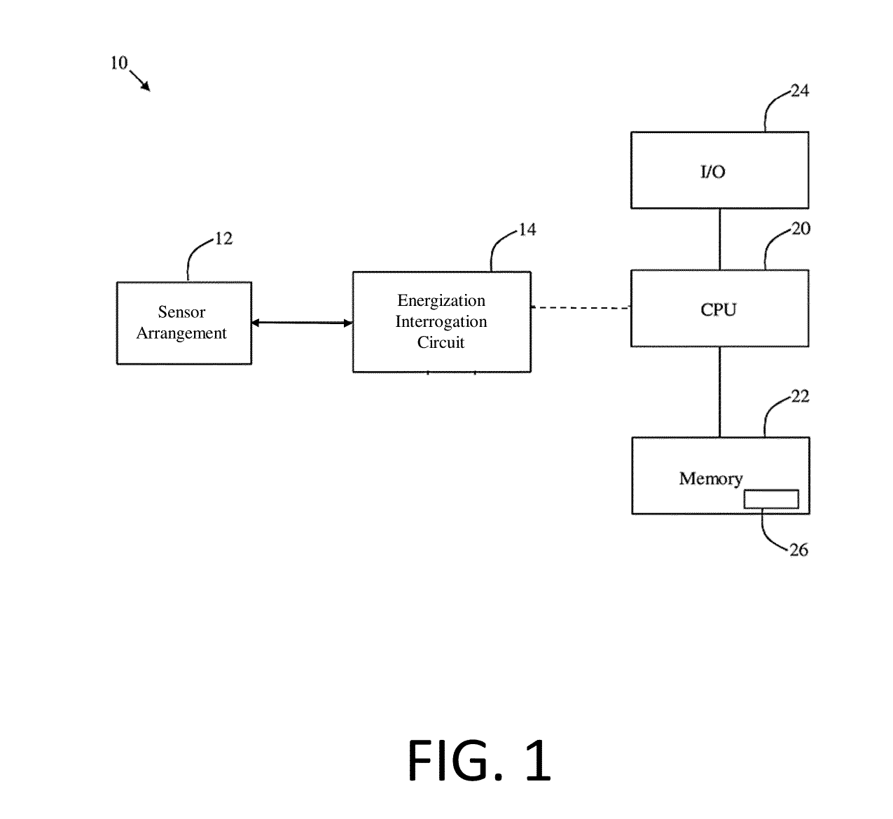

FIG. 1 is a block diagram of an exemplary system for energization and interrogation of a corrosion sensor arrangement, according to the present disclosure. In this description the corrosion sensor arrangement of this disclosure is also interchangeably referred to as a corrosion sensor or simply a sensor. The system 10 includes a sensor arrangement 12, an energization-interrogation circuit block 14, a processing circuit 20, a memory block 22 and an input/output (I/O) device 24. The I/O device 24 may include a user interface, graphical user interface, keyboards, pointing devices, remote and/or local communication links, displays, and other devices that allow externally generated information to be provided to the system 10, and that allow internal information of the system 10 to be communicated externally.

The processing circuit 20 may suitably be a general purpose computer processing circuit such as a microprocessor and its associated circuitry. The memory block 22 may suitably be various memory and data storage elements associated with a general purpose computer. Within the memory block 22 are various instructions in a program instruction block 26 within the memory block 22. The processing circuit 20 is configured to execute the program instructions 26 to carry out the various operations.

The processing circuit is also connected to the I/O device 24 to receive data from, and present data to a user. The processing circuit 20 is also connected to the energization-interrogation circuit block 14 to receive data from, and send data to, the energization-interrogation circuit block 14. This connection is shown in dashed lines to indicate that the connection can be a wired connection or a wireless connection, including a cellular, radiofrequency-based, Bluetooth-based, or based on any other wireless communication protocol known to a person having ordinary skill in the art. The data communicated between the processing circuit 20 and the energization-interrogation circuit block 14 includes the energization signal as well as the readout data (also referred to herein as the interrogation data).

The memory block 22 may include random access memory (RAM), read only memory (ROM), programmable read only memory (PROM), erasable programmable read only memory (EPROM), or electrically erasable read only memory (EEPROM), and other types of memory known in the art suitable for storing data. The data may be of the type that continuously changes, or of the type that changes during operations of the energization-interrogation circuit block 14.

It should be appreciated that while only one sensor arrangement is depicted in FIG. 1, multiple sensors can be combined to provide a network of sensors in the system 10. Each of these sensors 10 is coupled to the energization and interrogation circuit 14 via a networked connection, e.g., a multiplexer.

A corrosion sensor arrangement to automatically monitor the extent of corrosion in various structures is disclosed. The sensor arrangement includes a capacitor composed of two parts. The first part is substantially same material in construction as the structure to be monitored. The second part is a corrosion resistant conductor. The two parts are separated by the environment of the structure to be monitored. During the course of early stage corrosion and degradation, there is a change in the electrical properties of the first part. As a result, the degree of corrosion is reflected by a systematic change of the capacitance and resistance readings from the sensor. As mentioned above, the sensor can be connected to wired or wireless networks for automatic data acquisition and processing. Multiple sensors can be deployed at various locations of the structure to provide a comprehensive monitoring system without the need for a site visitation, resulting in cost savings.

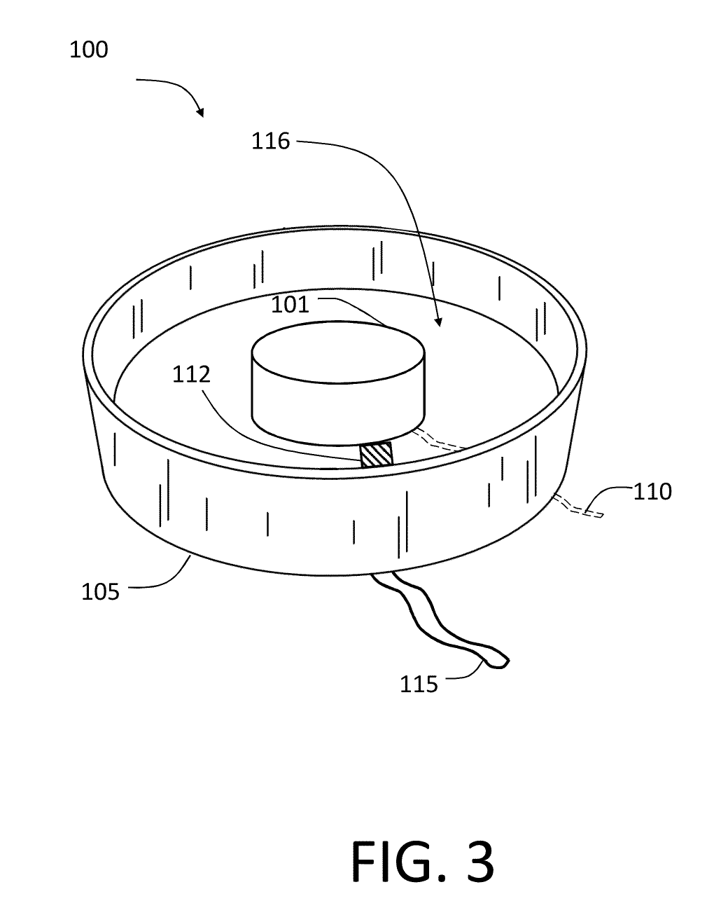

In one embodiment, a corrosion sensor is described with ability to indicate a systematic change in electrical properties of a metal (e.g., A36 carbon steel as investigated in this study) during the early-stage of corrosion as it is exposed to a corrosive environment. A36 carbon steel is commonly used in steel bridges and other structures. The definition of early-stage corrosion is where the mass change of the sensor is within 0.2%. In this embodiment, a corrosion sensor is made for measuring the corrosion of a structure made substantially of A36 steel with a corrosion resistant coating. In this case, the first part of the sensor is made substantially of A36 steel with the corrosion resistant coating, and a second part is made of 316 stainless steel, the first and second parts being separated by environment in proximity to the structure, thereby forming a capacitor, as further described with reference to FIG. 3, below. The sensor can be characterized by a resistance and a capacitance. The resistance and capacitance changes in the capacitor provide a measure of corrosion occurring in the structure.

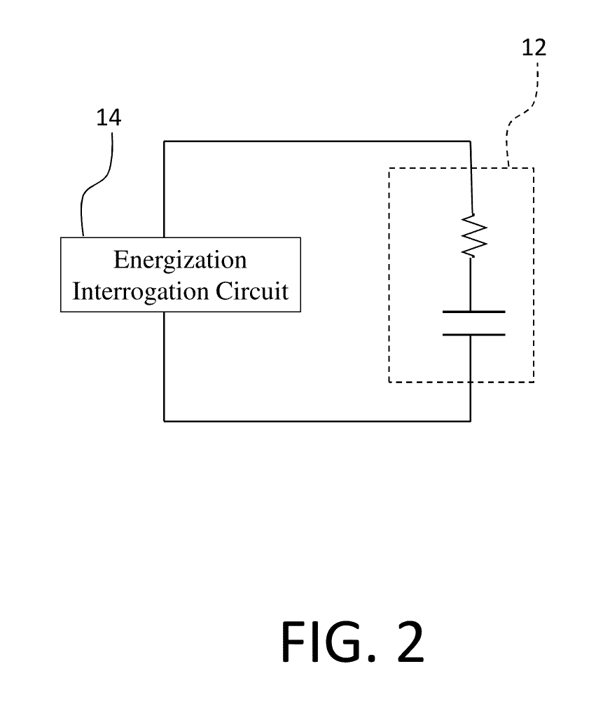

Referring to FIG. 2, resistance and capacitance values of the corrosion sensor installed in close proximity to the structure whose corrosion is monitored through the use of the corrosion sensor are schematically represented. The resistance and capacitance of the sensor 12 are measured utilizing a measurement system (identified in FIG. 2 as the energization and interrogation circuit 14) schematically shown in FIG. 2, and further described below.

FIG. 3 is an exemplary perspective view of a corrosion sensor 100 comprising a cylindrical capacitor used for corrosion monitoring in the above mentioned embodiment of the present disclosure. With reference to FIG. 3, the sensor 100 includes an inner cylinder 101 (which is constructed from A36 steel rod with a diameter of 1.27 cm and a height of 0.64 cm, according to only one exemplary embodiment). It should be noted that ASTM A36 steel contains at least 99.05% of Fe, and max 0.26% C, max 0.04% P, max 0.05% S, max 0.40% Si, and max 0.20% Cu. The sensor further includes an outer cylinder 105 made from a corrosion resistant but electrically conducting material (which is constructed from a 316 stainless steel ring with inner diameter of 2.22 cm, outer diameter of 2.54 cm, and a height of 0.64 cm, according to only one exemplary embodiment). The inner cylinder 101 may have a corrosion resistant coating (not shown) which is substantially similar to a coating of a structure whose corrosion is to be monitored. For example, if a bridge structure is to be monitored, and the structure made from A36 steel is painted, the corrosion resistant coating (not shown) can be the same paint that is applied to the structure. The A36 steel rod 101 is polished (e.g., by a 3M 80 grit followed by 3M 600 grit sandpaper). A connecting bridge 112 made of an insulator (e.g., plastic) is coupled through a waterproof adhesive (e.g., epoxy: 15206 ANCHOR-TITE, SUPER GLUE) on the bottom of both the inner cylinder 101 and the outer cylinder 105 to fix their relative positions with respect to each other. It should be noted that in this disclosure the reference numeral 101 is used to refer to the inner cylinder as well as the A36 steel rod. Likewise, the reference numeral 105 is used to refer to the outer cylinder as well as the 316 stainless steel ring. A wire 110 is coupled to the inner cylinder 101 and another wire 115 is coupled to the outer cylinder 105. The wire 110 is attached (e.g., soldered) to the inner cylinder 101 (e.g., the base) and the wire 115 was is attached (e.g., welded) to the outer cylinder 105 (e.g., the base). A waterproof adhesive (e.g., epoxy) is used to cover the connections of the wires 110 and 115 as well as the base of the inner cylinder 101 to prevent corrosion of the connections and the wires. In one embodiment, after being soaked in an aerated 0.2 M NaCl solution, the electrical resistance of the sensor 100 decreases from 48.65×10⁶ to 36.24×10⁶Ω and from 7.25×10⁶ to 4.66×10⁶Ω for the measurement modes of in parallel and in series, respectively. Meanwhile, the capacitance of the sensor 100 increases from 7.8 to 11.4 pF and from 9.2 to 13.1 pF for measurement modes of in-parallel and in-series, respectively. Also shown in FIG. 3 is a medium 116 between the inner cylinder 101 and the outer cylinder 105, when the sensor 100 is dried. The medium 116 can be air or other electrically insulating material which allows rust to be formed on the inner cylinder 101. As a result, the degree of corrosion is directly reflected by the systematic change of the capacitance and resistance readings from the sensor 100.

A 500-ml 0.2 M sodium chloride solution was used to simulate corrosion. An air pump (AQUA CULTURE) with a flow rate of ˜1.2 L/min was continuously bubbling air through a diffuser to the solution to provide oxygen for the corrosion process. The air diffuser was a porous sandstone. The dissolved oxygen level of the NaCl solution was maintained at around 8.8 mg/L. The corrosion sensor 100 was submerged in the sodium chloride solution above the air diffuser.

Every day during the course of the test, the sensor 100 was removed from the solution, rinsed with de-ionized (DI) water, dried at room temperature for 2-3 hours, and then tested with an resistance-capacitance-inductance (RCL) meter. At each measurement, multiple readings from the RCL meter were recorded at specific times until stable readings were obtained, indicating the senor 100 was dried with equilibrium to air moisture. As a result, the sensor 100 experienced periodically wet/dry cycles twice a day for total 11 days. A new 0.2 M sodium chloride solution was made daily. The accumulated corrosion time of the senor 100 in the sodium chloride solution was 225.5 hours. As a control test, a 316 stainless steel ring was soaked in an aerated 500-mL 0.2 M sodium chloride solution separately to investigate the degree of corrosion of the 316 stainless steel.

An automatic RCL meter (PM6303A, FLUKE) was used to measure the resistance and the capacitance of the corrosion sensor 100 in both parallel and series modes, which were the built-in functions of the meter. This meter is an example of the measurement system (identified also as Energization and Interrogation Circuit) which is referred to in FIG. 2. The meter used a frequency of 1 kHz and a voltage of 1.9 V for the measurements. The RCL meter also measured dissonance factor, quality factor, impedance, and the phase angle. In addition, the mass of the dried sensor 100 was examined by a digital balance (ESA-3000, SALTER-BRECKNELL) with a precision of 0.05 g. The initial weight of the sensor 100 was 25.20 g. For the corrosion sensor 100, the initial series and parallel resistances (R₀) were 48.65×10⁶ and 7.25×10⁶Ω, respectively; the initial parallel and series capacitance (C₀) were 7.8 and 9.2 pF before the start of the corrosion test. After the sensor 100 was removed from the NaCl solution, the daily solution samples were acidified with ACS grade nitric acid from MALLINCKRODT to 10% (v/v) to dissolve the iron rust in the solution. Atomic absorption spectroscopy (AANALYST 200, PERKIN ELMER) was utilized to measure the dissolved iron in the solution. The crystalline substances on both of the corroded and uncorroded A36 steel surface was examined by X-ray diffraction (XRD) with CuKα radiation (APD3520, PHILIPS). For the uncorroded sample, a piece of the A36 steel of 1.27 cm diameter and 0.2 cm thickness was polished by a 3M 80 grit then a 3M 600 grit sandpaper. The steel sample was cleaned by blowing thoroughly with compressed nitrogen. For the corroded sample, the same polishing procedures were followed as the uncorroded sample, then the A36 steel sample was submerged in the aerated 500-mL 0.2 M sodium chloride solution for 225.5 hours. The corroded steel sample was rinsed with DI water and dried in air for XRD examination.

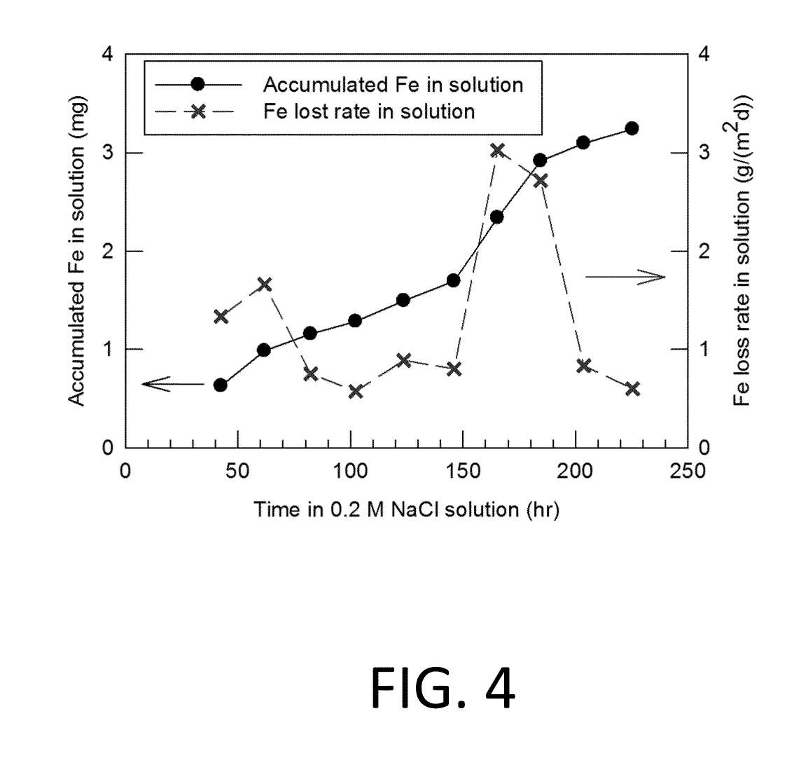

As part of the corrosion test a new cylindrical corrosion sensor 100 was made of a rust-free A36 carbon steel rod 101 in the center and the 316 stainless steel ring 105 as outer cylinder. Two electrical wires were connected to them respectively. During the corrosion test, rust was visually observed on the A36 steel rod 101 as early as 2 hours of exposure to the aerated 0.2 M NaCl solution. In the meantime, the NaCl solution turned yellowish in color with suspended small rust particles. After accumulated 225.5 hours in the aerated 0.2 M NaCl solution, rust was very apparent and had covered a large surface area of the A36 steel rod 101. However, as expected, no visible corrosion was observed for the 316 stainless steel ring 105. During the corrosion process, yellowish iron rust was continuously released from the sensor to the NaCl solution. The amount of iron in the solution was quantified by atomic absorption spectroscopy after dissolution of the rust with nitric acid. FIG. 4 is a graph of iron loss rate and accumulated iron loss vs. time in the 0.2M NaCl solution during the corrosion test. As shown in FIG. 4, 0.16˜0.81 mg of iron was released from the sensor to the solution per day. At the end of the test of 225.5 hours, 3.24 mg of the accumulated iron was in the solution. The corresponding corrosion rate varied between 0.60 and 3.02 g/(m²·d). However, for the control test of the 316 stainless steel ring 105 alone, the dissolved iron concentration was less than 0.02 mg at the end of 225.5 hours of corrosion, indicating the corrosion was insignificant. It should be noted that there was rust on the surface of the A36 steel rod 101 as well in addition to the amount found in the NaCl solution. The rust was not cleaned from the sensor intentionally to maintain its natural condition during the corrosion process. As a result, the overall iron loss and corrosion rate should be greater than that found in the solution as shown in FIG. 4. As seen in FIG. 4, the rate at which Fe is lost varies over time (i.e., varied corrosion rate). The varied corrosion rate in this study is likely due to different amounts of rust spalling from the sensor 100 from time to time, which can affect the quantity of iron in the solution suddenly.

Despite apparent corrosion of the A36 steel rod 101 through visual observations, the mass of the sensor was maintained constant at 25.20±0.05 g (i.e., variation was within ±0.2%) throughout the test. This result is consistent with FIG. 4, in which the iron loss in the solution was within the mg range. Based on the reactions (1) to (9), discussed below, the loss of iron (Fe) from the sensor can be compensated by gains of oxygen and hydrogen atoms in the rust. As a result, mass is not a sensitive parameter to evaluate corrosion. On the other hand, the minor change of the mass suggests the early-stage corrosion. This result suggests that the air gap between the A36 steel rod 101 and the 316 stainless steel ring 105 of the sensor did not enlarge, which is important evidence for the explanation of the electrical resistance and the capacitance change of the sensor.

The corrosion of carbon steel can occur as an electrochemical reaction, with one anodic reaction and one cathodic reaction. The anodic reaction usually occurs as:

Fe→Fe²⁺+2e⁻ (1).

The cathodic reaction, however, can be different depending on what is in the environment. This cathodic reaction is the main factor that influences the rate of corrosion.
In the aerated solution:

O₂+2H₂O+4e⁻→4OH⁻ (2).

Combining the reactions of the cathodic and anodic reactions gives:

2Fe+O₂+2H₂O→2Fe(OH)₂↓ (3).

As a result, ferrous hydroxide precipitates from the solution. However, dissolved oxygen can oxidize ferrous hydroxide to ferric hydroxide:

4Fe(OH)₂+O₂+2H₂O→4Fe(OH)₃↓ (4).

Yellowish/brownish rust was observed at the surface of A36 carbon steel 101 and in the solution. In addition, black rust was also seen on the A36 steel rod 101 underneath yellowish/brownish rust, which is likely magnetite (Fe₃O₄). The formation of magnetite is due to the iron not having enough oxygen present for the reaction. The following additional reactions may occur involving oxidation of iron and producing rusts at the surface A36 carbon steel rod 101.

Fe²⁺→Fe³⁺+e⁻ (5)

2Fe(OH)₂→Fe₂O₃+H₂O+2H⁺+2e⁻ (6)

4Fe(OH)₂+O₂→4FeOOH+2H₂O (7)

Fe²⁺+8FeOOH+2e⁻→3Fe₃O₄+4H₂O (8)

2FeO+H₂O→Fe₂O₃+2H⁺+2e⁻ (9)

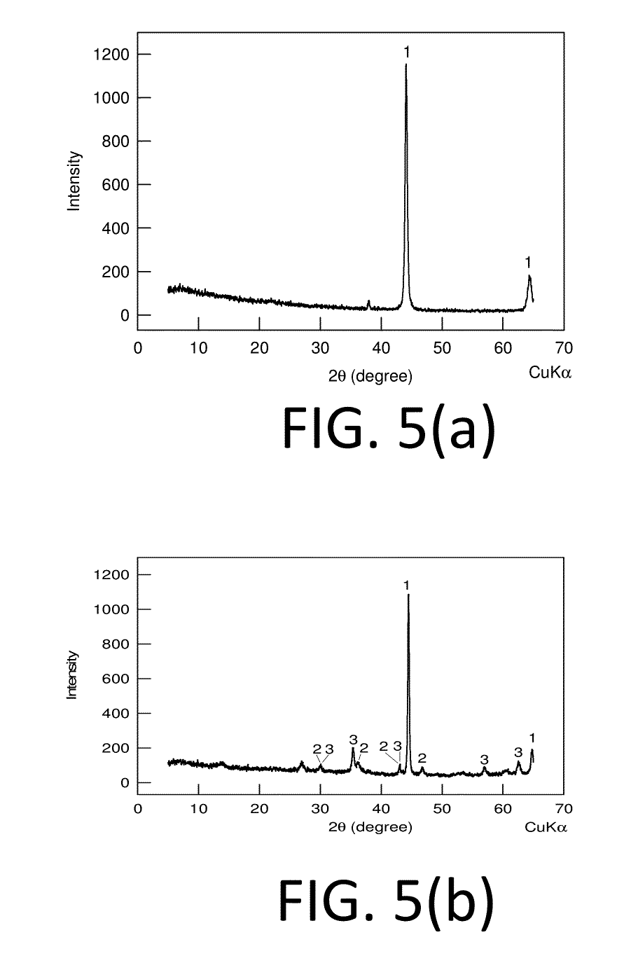

To examine the crystalline compositions of the iron rust on the surface of A36 steel rod 101, XRD (X-Ray Diffraction) analysis was performed with CuKα radiation. FIG. 5(a) shows the XRD spectrum of the uncorroded A36 steel rod 101 polished by sandpaper. FIG. 5(b) shows the XRD spectrum of the corroded A36 steel rod 101 soaked in the aerated 0.2 M NaCl solution for 225.5 hours. Three types of crystalline substances were found on the corroded steel surface according to their characteristic diffraction patterns, which were, referring to FIG. 5(b), 1: iron, 2: lepidocrocite, and 3: magnetite. Consistently, it has been reported in literature that the rust formed on steel surface is a mixture of lepidocrocite (γ-FeOOH), magnetite (Fe₃O₄), hematite (α-Fe₂O₃), goethite (λ-FeOOH), and amorphous iron oxide, although only the first two were found in this study. The resistivity and the dielectric constant of the rust materials, along with iron and air are listed in Table 1.

TABLE 1
Electrical resistivity and the dielectric constant of materials related to rust at ambient temperature.

| | | | | | amorphous | | |
|---|---|---|---|---|---|---|---|
| Materials | α-Fe₂O₃ | γ-FeOOH | Fe₃O₄ | α-FeOOH | Fe₂O₃ | iron | air |
| Electrical | (1.58-5.62) × 10⁴ | (0.20-0.80) × 10⁵ | 1.58 × 10⁻⁴ − 0.1 | (1.30-2.33) × 10⁵ | 2.12 × 10³ | 1.0 × 10⁻⁷ | 4 × 10¹³ |
| resistivity ρ | | | | | | | |
| (Ω · m) | | | | | | | |
| Dielectric | 12 | 2.6 | 20 | 11 | 4.5 | — | 1 |
| constant ∈ | | | | | | | |

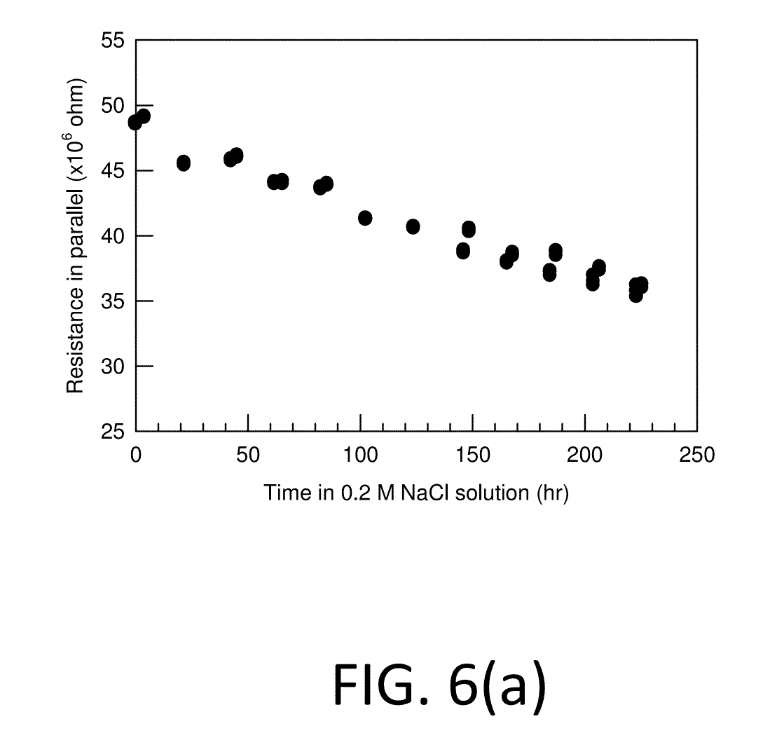

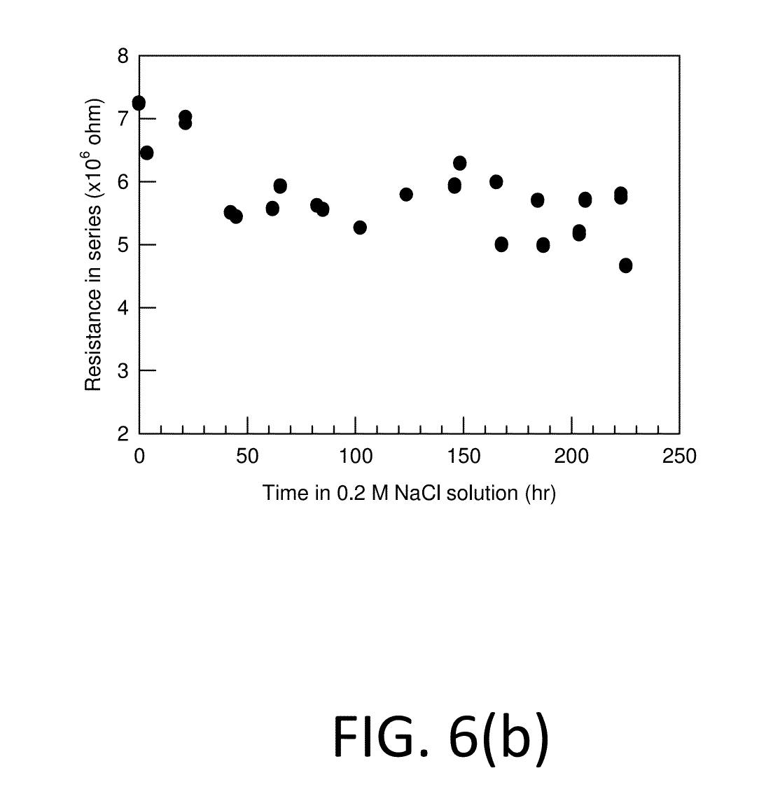

FIGS. 6(a) and 6(b) show electrical resistance of the sensor in parallel and in series (i.e., the built-in measurement mode of the RCL meter) with the extension of corrosion time in the NaCl solution, respectively. At each measurement, the sensor was removed from the NaCl solution, rinsed with DI water and allowed to dry in air for several hours before being tested with the RCL meter through the mode of electrical resistance in parallel or series as appropriate. In FIG. 6(a), during the course of corrosion, the resistance gradually decreased following an apparent trend. At the end of the corrosion test of 225.5 hrs the measured resistance in parallel was 36.24×10⁶Ω, a decline of 26% compared to the initial resistance. Consistently, as shown in FIG. 6(b), the electrical resistance in series of the sensor 100 also decreased with the corrosion time, although the fluctuation of the data was greater than shown in FIG. 6(a). The initial resistance of the sensor was 7.25×10⁶Ω. The value dropped to 4.66×10⁶Ω. after 225.5 hrs, a 36% decrease from the initial value.

The electrical resistance is expressed by the following equation.

$$R = \frac{ρ l}{A} \qquad ( 10 )$$

where,

R=electrical resistance of a material (Ω)

ρ=electrical resistivity of the material (Ω·m)

l=the length of the material (m)

A=the cross-sectional area of the material (m²).

The resistance of the new corrosion sensor is mainly due to the medium between the cylindrical A36 steel rod 101 and the 316 stainless steel ring 105 (see FIG. 3). Air has an electrical resistivity of 4×10¹³Ω·m. When corrosion of the A36 steel rod 101 happened, rust formed a porous and loose structure extended from the surface of A36 steel rod 101 to the surrounding air. As a result, the rust occupied part of the volume that was previously occupied by air. In other words, after corrosion, the gap between the A36 steel rod 101 and the 316 stainless steel ring 105 was partially filled with porous rust (small portion) and air (big portion). As mentioned earlier, the iron rust is a mixture of lepidocrocite (γ-FeOOH) and magnetite (Fe₃O₄) as shown in FIG. 5(b), along with possible hematite (α-Fe₂O₃), goethite (α-FeOOH) and amorphous iron oxide. As can be seen from Table 1, the electrical resistivity of the rust components is at least eight orders of magnitude lower than air. According to equation (10), a lower electrical resistivity gives rise to smaller resistance. Consequently, the electrical resistance in both parallel and series decreases with the time or the extent of corrosion. Although spalling of rust from the sensor could enlarge the air gap between the A36 steel rod 101 and the 316 stainless steel ring 105, the insignificant mass-loss result (i.e., mass change<0.2% or 187.7 g/m²) discussed earlier indicates this was not the case during the testing period of the early-stage corrosion. However, if significant spalling of rust happens and thus the air gap between the A36 steel rod 101 and the 316 stainless steel ring 105 increases, the trend of electrical resistivity might reverse (i.e. electrical resistance increases with time), suggesting much severe corrosion.

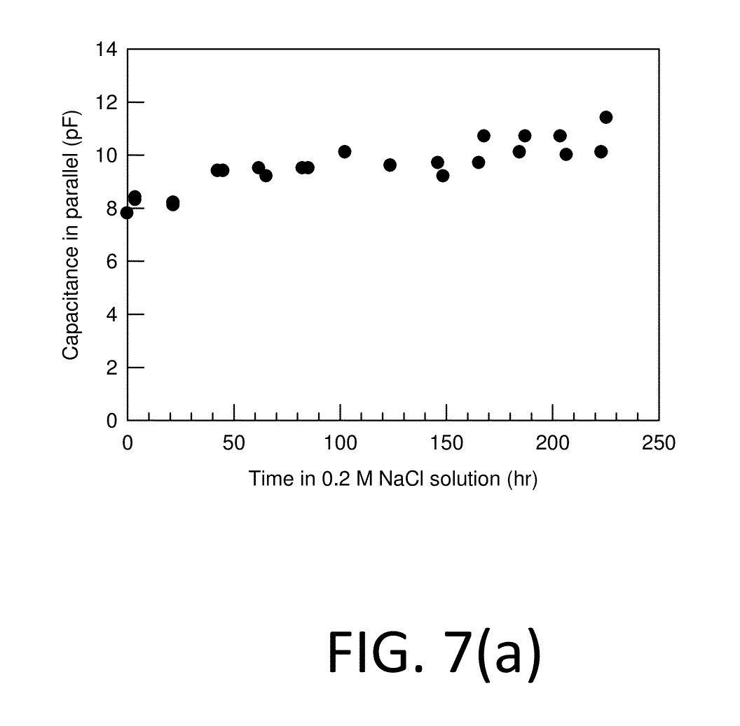

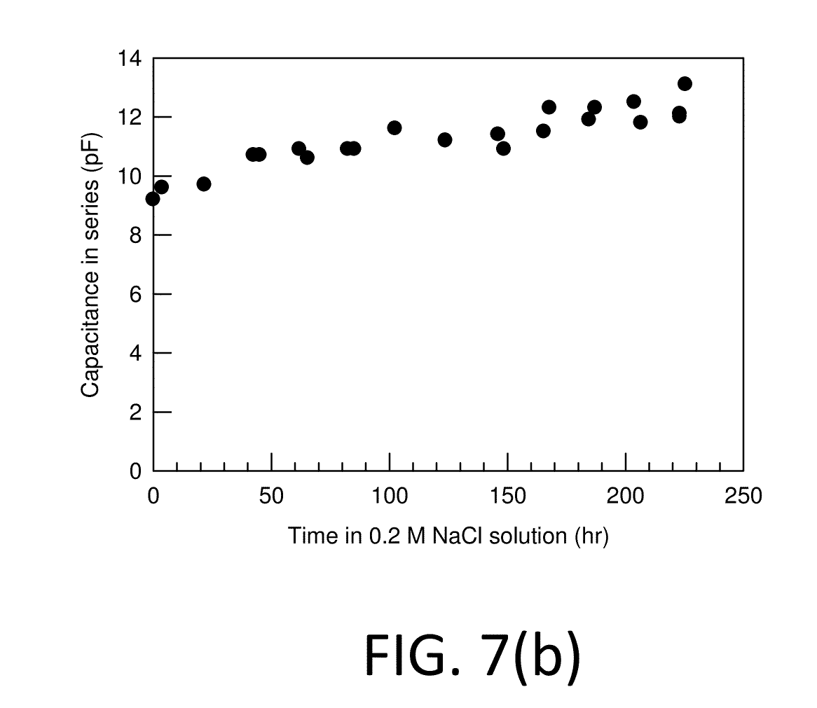

In addition to the electrical resistances, the capacitance of the sensor 100 in both parallel and series mode during corrosion was also examined. Again, capacitance in series and in parallel was from the measurement mode of the RCL meter. FIG. 7(a) shows the change of the capacitance in parallel vs. accumulated time of corrosion in the aerated 0.2 M NaCl solution. At each measurement, the sensor was removed from the NaCl solution, rinsed with DI water and allowed to dry in air for several hours before being tested with the RCL meter through the mode of electrical capacitance in parallel. A positive trend of the capacitance with the extent of corrosion was observed. More specifically, the capacitance in parallel increased from 7.8 pF at the beginning to 11.4 pF after 225.5 hours. In other words, the capacitance had an increase of 46%. FIG. 7(b) shows capacitance in series of the sensor 100 vs. the accumulated time in the aerated 0.2 M NaCl solution. At each measurement, the sensor 100 was removed from the NaCl solution, rinsed with DI water and allowed to dry in air for several hours before being tested with the RCL meter through the mode of electrical capacitance in series. A consistent result was also observed for the capacitance in series as shown in FIG. 7(b), where the capacitance rose from 9.2 pF at time zero to 13.1 pF at the end of the test time of 225.5 hours, a 42% increase.

The capacitance of the sensor 100 can be calculated from the following equation:

$$C = \frac{2 {πɛ}_{0} h * ɛ}{ln ( \frac{b}{a} )} \qquad ( 11 )$$

where:

C=capacitance (F)

ε₀=free space permittivity, 8.85 pF/m

h=height of the cylinder sensor (m)

ε=dielectric constant of the material(s) between the A36 steel rod 101 and the 316 stainless steel ring 105

b=inner radius of the 316 stainless steel ring 105 (m)

a=radius of the A36 steel rod 101 (m)

Before corrosion, air was between the A36 steel rod 101 and the 316 stainless steel ring 105. Air has a dielectric constant ε of 1. As indicated above, however, air can be substituted with other electrically insulating material. After corrosion, rust was formed at the surface of A36 steel rod 101. It means the gap between the A36 steel rod 101 and the 316 stainless steel ring 105 was filled with both rust and air, although rust has a much smaller volume compared to air. As shown in Table 1, the dielectric constant ε of the substances composing the iron rust ranges from 2.6 to 20, much greater than air. Moreover, porous rust slightly increases the radius a of the A36 steel rod 101. As a result, an increase in both ε and a of the sensor 100 raises the capacitance of the corrosion sensor, according to Equation (11). Again, spalling of the rust from the A36 steel rod 101 and thus a decrease of a was insignificant during the early-stage corrosion, because of the measured almost constant mass of the sensor during the test. Consequently, a higher capacitance reading in both parallel and series reflects more rust formation at the surface of A36 steel rod 101 of the sensor during corrosion.

Automatic detection of the early-stage corrosion is highly important to find the potential problem and apply corrosion control techniques timely for safety and integrity concerns. From the description above it can be seen that an innovative cylindrical corrosion sensor 100 made of A36 carbon steel rod 101 (representing the material of a structure or a system to be monitored for corrosion) and a 316 stainless steel ring 105 (representing an inert material of low corrosion potential) is disclosed. A capacitor was formed with both metals separated by air. After corrosion in an aerated 0.2 M NaCl solution for 225.5 hours, the cylindrical corrosion sensor 100 has shown a systematic decrease in the electrical resistance from 48.65×10⁶ to 36.24×10⁶Ω and from 7.25×10⁶ to 4.66×10⁶Ω corresponding to the RCL meter's measuring mode of in parallel and in series, respectively. In the same time, the capacitance of the sensor increased from 7.8 to 11.4 pF and from 9.2 to 13.1 pF for the measurement mode of in parallel and in series, respectively. However, the weight change of the sensor 100 was within 0.2%, an indication of the early-stage corrosion. In the same time, the reference senor, which was not subject to corrosion apparently, showed a stable normalized reading about 1.0. X-Ray Diffraction (XRD) result shows that the rust contained lepidocrocite and magnetite. By attaching the corrosion sensor 100 with the identical passivation/coating to a steel structure, the extent of corrosion of the structure can be directly reflected by the electrical resistance decrease and/or capacitance increase of the sensor 100 during the early-stage corrosion. Multiple corrosion sensors can be connected to a wired or wireless network for automatic data acquisition, processing, and evaluation.

In practice, the sensor 100 can be connected to a wired or wireless network for automatic data acquisition, processing and storage. Multiple sensors can be deployed at varied locations of a structure to provide a comprehensive monitoring network without the need for a site visitation. Thus it is more efficient and cost-saving. This arrangement can make it possible to remotely monitor the extent of corrosion of a structure or a system to which the sensors are attached, thereby providing a way to automatically determine the degree of the early-stage corrosion of steel and steel structures during service. Such a solution provides an opportunity to estimate the integrity of the infrastructures and to apply corrosion-control measures timely, so that a catastrophic failure could be prevented.

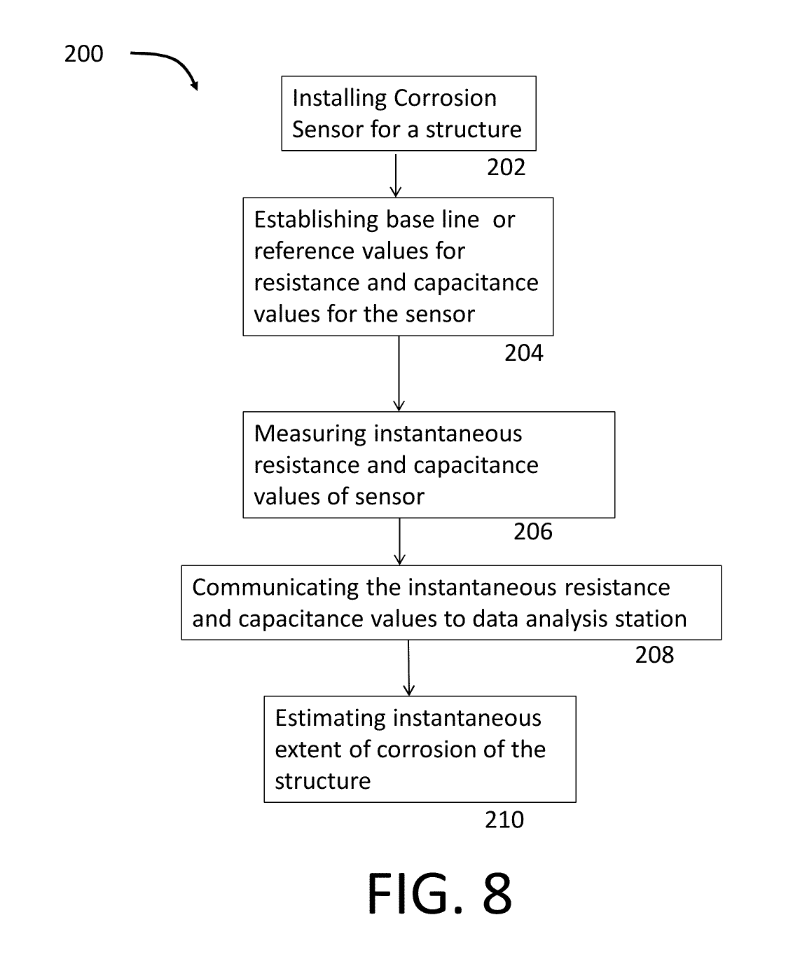

In operation, and with respect to FIG. 8, a method of use 200 of the corrosion sensor arrangement, according to the present disclosure, is described. FIG. 8 is a schematic representation of the method employed in using a corrosion sensor to monitor the corrosion of a structure. A corrosion sensor is installed in proximity to the structure (202). A baseline value set or a reference value set for resistance and capacitance values of the sensor is established (204). These baseline or reference values can be, as a non-limiting example, initial resistance and capacitance values of the corrosion sensor. Instantaneous resistance and capacitance values from the sensor are measured (206). The values are then transmitted to a data analysis station (208), as described with reference to FIG. 1. The data analysis station has the capability to compare the resistance and capacitance values to the baseline. The data analysis station further has the capability to estimate the extent of the corrosion occurring in the structure according to a predetermined criterion (210). One predetermined criterion can be a percent change in capacitance and/or resistance from the baseline values (e.g., 20% change).

In an alternate embodiment of this disclosure, a reference sensor can be made and used as described later. In this embodiment a reference sensor and the corrosion sensor 100 are both subjected to the same environment. A reference sensor is made by following the same procedures and dimensions as described for sensor 100 except both cylindrical parts are corrosion resistant conductors. For purposes of this alternate embodiment, a reference sensor is made by following the same procedures and dimensions as for the sensor shown in FIG. 3 replacing the A36 carbon steel by a 316 stainless steel with the same dimension and corrosion resistant coating as inner cylinder 101. That is in constructing a reference sensor, both parts are made of corrosion resistant material, which in this example is 316 stainless steel. The reference sensor, also referred alternatively in this description as stainless steel reference sensor, serves to provide a type of baseline information by addressing environmental conditions such as the temperature and the moisture level of air other than corrosion. In all other respects, the reference sensor is constructed utilizing substantially the same materials and techniques as sensor 100.

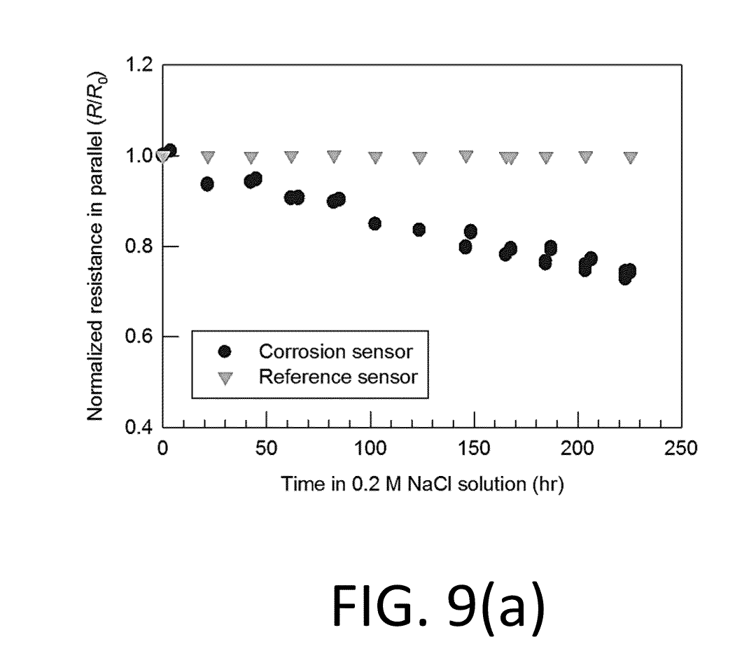

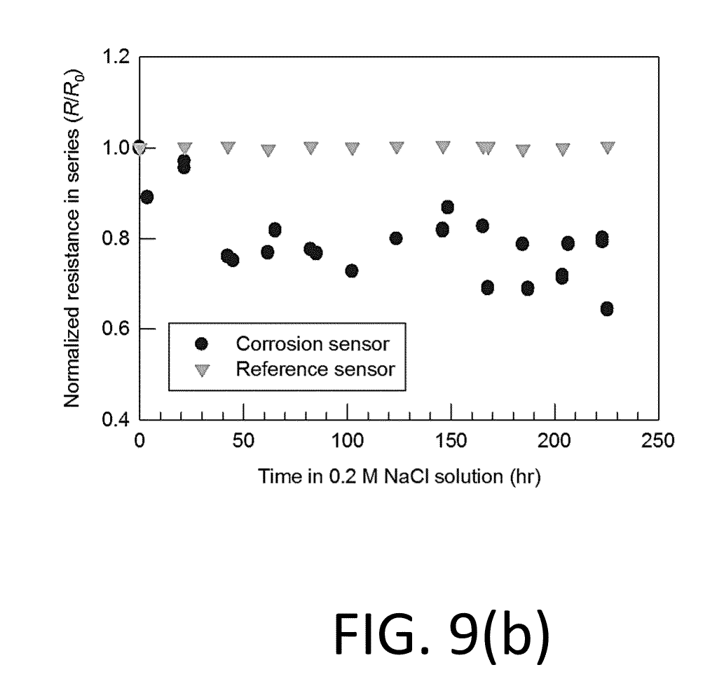

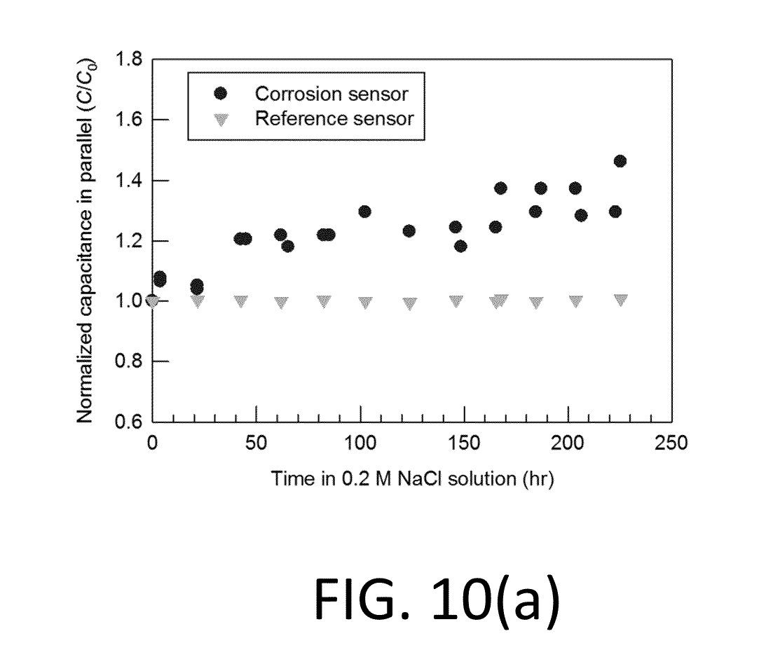

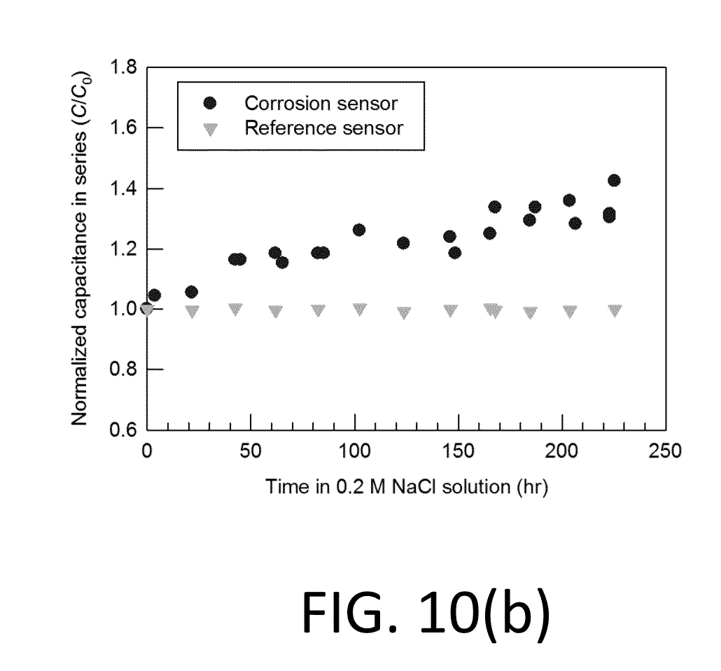

The studies made utilizing a reference sensor are described below. For the corrosion sensor 100, the initial resistance (R₀) in parallel and in series was 48.65×10⁶ and 7.25×10⁶Ω, respectively; the initial capacitance (C₀) in parallel and in series was 7.8 and 9.2 pF before corrosion test. For the stainless steel reference sensor, the initial resistance in parallel and in series was 37.66×10⁶ and 1.05×10⁶Ω, respectively; the initial capacitance (C₀) in parallel and in series was 24.9 and 25.6 pF, respectively. The resistance and capacitance measurement procedures employed to measure were substantially similar to those described with reference to sensor 100 above. In this embodiment the resistance R of sensor 100 was measured and normalized with respect to the reference sensor as normalized resistance R/R₀. FIG. 9(a) is a graph of normalized parallel resistance of the corrosion sensor (normalized to the parallel resistance of the reference sensor) vs. time (hr) in NaCl solution. FIG. 9(a) shows during the course of corrosion the normalized resistance gradually decreased. At the end of the corrosion test of 225.5 hrs, the normalized resistance (R/R₀) in parallel decreased from 1.0 to 0.74, a decline of 26%. FIG. 9(b) is a graph of normalized series resistance of the corrosion sensor (normalized to the series resistance of the reference sensor) vs. time (hr) in NaCl solution. As shown in FIG. 9(b), the electrical resistance in series of the sensor also decreased with the corrosion time, although the fluctuation of the data was greater than FIG. 9(a). The normalized resistance of the sensor dropped to 0.64 after 225.5 hrs, a 36% decrease from the initial value. Using the reference sensor, capacitance C of sensor 100 was measured and normalized with respect to the reference sensor as normalized capacitance (C/C₀). FIG. 10(a) is a graph of normalized parallel capacitance of the corrosion sensor (normalized to the parallel capacitance of the reference sensor) vs. time (hr) in NaCl solution. FIG. 10(a) shows the change of the capacitance in parallel vs. accumulated time of corrosion in an aerated 0.2 M NaCl solution. A positive trend of the capacitance with the extent of corrosion was observed. More specifically, the normalized capacitance (C/C₀) in parallel increased from 1.0 at the beginning to 1.46 after 225.5 hours. In other words, the capacitance had an increase of 46%. FIG. 10(b) is a graph of normalized series capacitance of the corrosion sensor (normalized to the series capacitance of the reference sensor) vs. time (hr) in NaCl solution. As shown in FIG. 10(b), the normalized capacitance (C/C₀) rose from 1.0 to 1.42 at the end of the test of 225.5 hours. In one embodiment of the reference sensor, the initial resistance in parallel and in series was 37.66×10⁶ and 1.05×10⁶Ω, respectively; and the initial capacitance (C₀) in parallel and in series was 24.9 and 25.6 pF, respectively.

Thus, utilizing a reference sensor, the cylindrical corrosion sensor 100 has shown a systematic decrease in the normalized electrical resistance (R/R₀) from 1.0 to 0.74 and to 0.64 corresponding to the RCL meter's built-in measuring mode of in parallel and in series, respectively. In the same time, the normalized capacitance (C/C₀) of the sensor increased from 1.0 to 1.46 and to 1.42 for the measurement mode of in parallel and in series, respectively. However, the weight change of the sensor was within 0.2% (or 187.7 g/m²), an indication of the early-stage corrosion. In the same time, the reference senor, which was not subject to corrosion apparently, showed a stable normalized reading about 1.0.

By attaching the corrosion sensor 100 and the reference sensor with substantially identical passivation/coating to a steel structure, the extent of corrosion of the structure can be directly reflected by the electrical resistance decrease and/or capacitance increase of the sensor 100 during the early-stage corrosion. Multiple corrosion sensors can be connected to a wired or wireless network for automatic data acquisition, processing, and evaluation.

It should also be noted that when using corrosion sensor 100 along with a reference sensor, the method described in FIG. 8 can be modified to establish a reference sensor instead of establishing a set of baseline values for resistance and capacitance values of the sensor, and utilizing normalized resistance and normalized capacitance values, both normalized with respect to the reference sensor to monitor the extent of corrosion. As a non-limiting example of such modification, a method of measuring the extent of corrosion of a structure can include installing a reference sensor and a corrosion sensor. The instantaneous resistance and capacitance values of the reference sensor and the instantaneous resistance and capacitance values of the corrosion sensor are measured and transmitted to a data analysis station. Although, it should be noted that since the resistance and capacitance of the reference sensor changes insignificantly, values associated with the reference sensor can be communicated once or less frequent than the corrosion sensor. The instantaneous resistance and capacitance values of the corrosion sensor are normalized with respect to the instantaneous resistance and capacitance values respectively of the reference sensor, and the extent of corrosion of the structure is estimate, as before, according to a predetermined criterion. One predetermined criterion can be a set value for the normalized instantaneous resistance and/or capacitance values.

While the present disclosure has been described with reference to certain embodiments, it will be apparent to those of ordinary skill in the art that other embodiments and implementations are possible that are within the scope of the present disclosure without departing from the spirit and scope of the present disclosure. It is therefore intended that the foregoing detailed description be regarded as illustrative rather than limiting.

1. A corrosion sensor, comprising:
a first part made substantially similar in material construction to a structure, corrosion on which is to be sensed by the corrosion sensor; and
a second part made of a corrosion-resistant material, the first and second parts being separated by a medium, thereby forming a capacitor,
the capacitor configured such that change in the capacitance provides a measure of corrosion occurring in the structure.

2. The corrosion of sensor of claim 1, the medium is air.

3. The corrosion sensor of claim 1, the medium represents an environment in which corrosion is to be sensed.

4. The corrosion sensors of claim 1, the first part and the second part are concentric cylinders.

5. The corrosion sensor of claim 1, the first part is made of A36 steel and the second part is made of 316 stainless steel.

6. The corrosion sensor of claim 5, the first part is inner cylinder and the second part is outer cylinder.

7. The corrosion sensor of claim 1, the first part includes a corrosion-resistant coating.

8. The corrosion sensor of claim 1, the first part includes a passivation coating.

9. A corrosion sensing system for measuring the corrosion of a structure, comprising:
at least one corrosion sensor, comprising:
a first part made substantially similar in material construction to a structure,
corrosion on which is to be sensed by the corrosion sensor, and
a second part made of a corrosion-resistant material, the first and second parts being separated by a medium, thereby forming a capacitor,
the capacitor configured such that change in the capacitance provides a measure of corrosion occurring in the structure;
at least one reference sensor comprising:
a first and second corrosion resistant parts made of a corrosion-resistant material, the first and second corrosion resistant parts being separated by a reference medium, thereby forming a reference capacitor, substantially unaffected by corrosion occurring to the at least one corrosion sensor; and
an energization and interrogation circuit configured to energize and measure resistance and capacitance of the at least one corrosion sensor and the at least one reference sensor and communicate the measured values to a base station.

10. The corrosion sensing system of claim 9, the communication to the base station occurs in one of a wired and a wireless mode.

11. The corrosion sensing system of claim 9, the first part and second part of the at least one corrosion sensor are concentric cylinders.

12. The corrosion sensing system of claim 11, the first part of the at least one corrosion sensor is an inner cylinder and the second part of the at least one corrosion sensor is an outer cylinder.

13. The corrosion sensing system of claim 9, further comprising a plurality of corrosion sensors.

14. A method of estimating extent of corrosion of a structure, comprising:
installing at least one corrosion sensor in close proximity to a structure, the corrosion sensor comprising:
a first part made substantially similar in material construction to the structure, and
a second part made of a corrosion-resistant material, the first and second parts being separated by a medium, thereby forming a capacitor,
the capacitor configured such that change in the capacitance provides a measure of corrosion occurring in the structure;
establishing a set of baseline of values for resistance and capacitance values for the at least one corrosion sensor,
measuring instantaneous resistance and capacitance values of the at least one corrosion sensor;
communicating the instantaneous resistance and capacitance values to a data analysis station; and
estimating the instantaneous extent of corrosion of the structure based on the communicated instantaneous resistance and capacitance values.

15. The method in claim 14, the communicating the resistance and capacitance values occurs in one of a wired and wireless mode.

16. The method in claim 14, the medium is air.

17. The method of claim 16, the at least one corrosion sensor is a plurality of corrosion sensors.
